(19) United States
(12) Patent Application Publication
(10) Pub. No.: US 2025/0342540 A1
(43) Pub. Date: Nov. 6, 2025

(54) SUBSCRIPTION MANAGEMENT FOR UTILITY DATA

(71) Applicant: Apple Inc., Cupertino, CA (US)

(72) Inventors: Atakan ESEN, San Diego, CA (US); Dakshil H. SHAH, San Jose, CA (US); Dharini SITARAMAN, San Jose, CA (US); Joelle L. LAM, Los Alto Hills, CA (US); Jordan M. HUGHES, Vista, CA (US); Nikhil S. PALEKAR, Redwood City, CA (US); Uved KHAN, San Diego, CA (US)

(21) Appl. No.: 18/898,539

(22) Filed: Sep. 26, 2024

Related U.S. Application Data
(60) Provisional application No. 63/643,366, filed on May 6, 2024.

(51) Int. Cl. G06Q 50/06

(52) U.S. Cl. CPC G06Q 50/06

(57) ABSTRACT

Aspects of the subject technology provide for providing utility data from a subscription server to a user device, where the utility data corresponding to utility usage information from a utility provider server and which is provided according to previously established subscription from the user device to the utility provider server. The utility data can be collected from the utility provider server and provided to the user device in a privacy preserving manner.

### CROSS REFERENCE TO RELATED APPLICATIONS

This application claims the benefit of U.S. Provisional Application No. 63/643,366, entitled “SUBSCRIPTION MANAGEMENT FOR UTILITY DATA,” filed May 6, 2024, the entirety of which is incorporated herein by reference.

### TECHNICAL FIELD

The present description relates generally to electronic devices, including, for example, managing a data subscription for utility usage information.

### BACKGROUND

As the world becomes more energy-aware and the cost of energy has increased, it may be desirable to some people to obtain and track utility usage information at, for example, their place of residence. On the utility provider side, utility providers may welcome customer engagement in exploring usage tracking and usage cutting techniques to reduce pressure on utility transmission channels.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a diagram of various example devices that may implement aspects of the subject technology in accordance with one or more implementations.

FIG. 2 illustrate a utility data flow between a utility meter, a utility provider server, a subscription server, and a user device for providing utility data to the user device, in accordance with one or more implementations.

FIG. 3 illustrates a flow diagram of an example process for providing utility data according to a subscription, in accordance with one or more implementations.

FIG. 4 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Users of electronic devices may rent or own a home that uses metered utilities, such as one or more of electricity, water, and gas. A subset of such users may utilize their electronic devices to log into a customer website or customer portal operated by the utility provider. At such customer websites, customers can view data about their usage and bills. However, some customers may never bother to set up their customer access to these customer portals and therefore do not receive usage information other than what is provided on a bill received at their mailing address or email address.

Some customers may utilize another service provider to facilitate establishing a subscription for utility usage data so that a utility provider can send utility usage data (which may also be referred to as “subscription data”) to the other service provider and the other service provider can provide the utility usage data as subscription data to the customer.

Aspects of the subject technology are concerned with the management of such subscription data, for example, how the subscription data is received at a subscription server, e.g., under control of the other service provider, noted above, how the subscription data is provided to the customer or subscriber, how the subscription service is terminated, paused, or resumed, how the subscription data can be augmented or presented in a manner which is more useful to the customer or subscriber, and maintaining privacy protection mechanisms so that the subscription service does not correlate the user data with a particular customer outside of the subscription service domain.

Therefore, the subject technology advantageously improves management of utility usage information at a subscription server in a privacy-preserving manner. This provides a solution to an inherently technical problem of preserving privacy of customer data which only exists because of the implementation of information sharing from a utility provider to a subscription service provider for the benefit of a customer of the utility provider. The solution to these and other problems described herein includes the use of a subscription server which collects subscription data from the utility provider server in a privacy preserving manner and provides the subscription data to the user device in a privacy preserving manner.

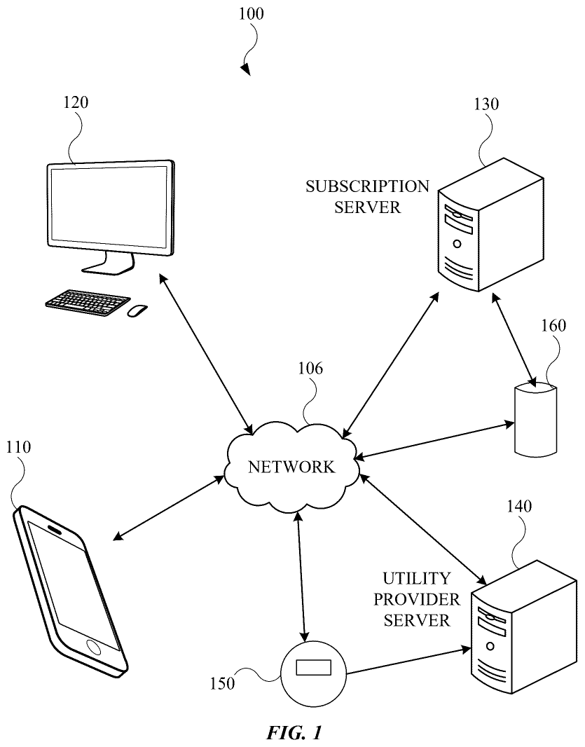

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a user device 110, a user device 120, an subscription server 130, a utility provider server 140, a utility meter 150, and a database server 160. The network 106 may communicatively (directly or indirectly) couple the user device 110 and/or the user device 120 to the subscription server 130 and/or the utility provider server 140 and/or the utility meter 150 and/or the database server 160. In one or more implementations, the network 106 may be an interconnected network of devices that may include, or may be communicatively coupled to, the Internet. For explanatory purposes, the network environment 100 is illustrated in FIG. 1 as including the user device 110, the user device 120, the subscription server 130, the utility provider server 140, a utility meter 150, and a database server 160; however, the network environment 100 may include any number of user devices and any number of servers or a data center including multiple servers. In particular, in some implementations, the subscription server 130 and/or the utility provider server 140 are representative of an array of servers which may be geographically diverse. Similarly, the utility meter 150 is representative of any number of utility meters metering any number of utility types.

In some implementations one or more of the user devices 110 and/or user devices 120 and/or utility meters 150 may not be connected to the network 106, but may be tethered to one of the other user devices 110 and/or 120 wirelessly or by a wired connection. In one or more implementations, the network 106 may include one or more different network devices/network medium and/or may utilize one or more different wireless and/or wired network technologies, such as Ethernet, optical, Wi-Fi, Bluetooth, Zigbee, Powerline over Ethernet, coaxial, Ethernet, Z-Wave, cellular, or generally any wireless and/or wired network technology that may communicatively couple two or more devices.

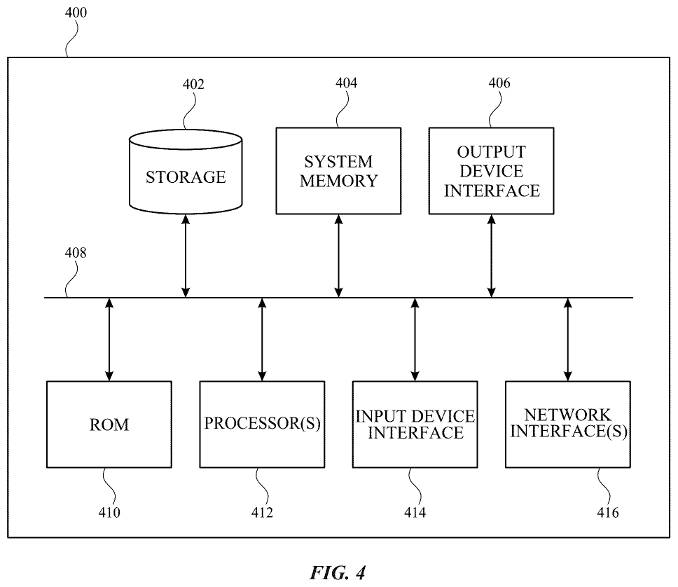

The user devices 110 and 120 may each be, for example, a desktop computer, a portable computing device such as a laptop computer, a smartphone, a peripheral device (e.g., a digital camera, headphones), a tablet device, a wearable device such as a watch a watch or a head mountable portable system, that includes a display system capable of presenting a visualization of an extended reality environment to a user, and the like. In FIG. 1, by way of example, the user device 110 is depicted as a mobile user device (e.g., smartphone). By way of example, the user device 120 is depicted as a desktop computer. The user device 110 may be, and/or may include all or part of, the electronic system discussed below with respect to FIG. 4.

In one or more implementations, one or more of the user devices 110 and/or 120 may execute an application that displays a user interface for obtaining utility usage information from a subscription server 130. The user interface may obtain utility usage information based on a subscription previously established through a utility provider server 140 with the subscription server 130 to obtain utility usage information from the subscription server 130 which was provided by the utility provider server 140. The application executed by the user devices 110 and/or 120 may interact with the subscription server 130 so that the application or other applications or system processes of the user devices 110 and/or 120 can retrieve subscription data relating to the subscription and use the subscription data.

The subscription server 130 may form all or part of a network of computers or a group of servers (where the subscription server 130 is representative of such a group of servers), such as in a cloud computing or data center implementation. For example, the subscription server 130 may include a processing server and/or a database server, which may be implemented on separate physical devices. For example, the subscription server 130 stores data and software, and includes specific hardware (e.g., processors, graphics processors and other specialized or custom processors) for rendering and generating content such as graphics, images, video, audio and multi-media files. In an implementation, the subscription server 130 may function as a subscription data manager server which interacts with the utility provider server 140 to receive or request subscription data, organize the subscription data, and provide the subscription data to the user devices 110 and/or 120. The subscription data may be organized and stored in a manner which specifically excludes user ID information for a user associated with the user devices 110 and/or 120. In such a manner, the privacy of the information can be protected. The subscription server 130 may be, and/or may include all or part of, the electronic system discussed below with respect to FIG. 4.

The utility provider server 140 may form all or part of a network of computers or a group of servers (where the utility provider server 140 is representative of such a group of servers), such as in a cloud computing or data center implementation. For example, the utility provider server 140 stores data and software, and includes specific hardware (e.g., processors, graphics processors and other specialized or custom processors) for rendering and generating content such as graphics, images, video, audio and multi-media files. In an implementation, the utility provider server 140 is associated with a utility provider where a user maintains a utility account and where usage data is available for the user utility account, and the utility provider server 140 may function to authenticate the user device 110 and/or 120 to receive utility usage information for the user associated both with the user device 110 and/or 120 as well as the utility provider. In an implementation, the utility provider server 140 may provide anonymized utility usage data to the subscription server 130 according to a subscription authentication set up between the user device 110 and/or 120. The utility provider server 140 may be, and/or may include all or part of, the electronic system discussed below with respect to FIG. 4.

The utility meter 150 may correspond to a computer-enabled utility meter that can record a digital representation of the metered utility usage. The utility meter 150 may be communicatively coupled to the utility provider server 140, for example, by means of an Internet connection, however, other communications methods utilized by the industries may be used. In some instances, the utility meter 150 may be communicatively coupled directly to one or more of the user devices 110 and/or 120. The utility meter 150 may be, and/or may include all or part of, the electronic system discussed below with respect to FIG. 4.

The database server 160 may form all or part of a network of computers or a group of servers (where the database server 160 is representative of such a group of servers), such as in a cloud computing or data center implementation. For example, the database server 160 stores data and software, and includes specific hardware (e.g., processors, graphics processors and other specialized or custom processors) for storing data in an organized format. In an implementation, the database server 160 is associated with the subscription server 130 and the user device 110 and/or 120. The database server 160 may function to store user utility usage data until the user retrieves the data to their own electronic device, e.g., user device 110 and/or 120. In an implementation, the subscription server 130 may store utility usage information based on a subscription ID. A user ID associated with the user, however, may not be stored in association with the utility usage data. In some aspects, the database server 160 may be considered a part of the subscription server 130, while in other aspects, the database server 160 may be considered distinct from the subscription server 130. When the database server 160 is distinct from the subscription server 130, the database server 160 may be accessible directly by the user device 110 and/or 120 without the need to access the subscription server 130. The database server 160 may be, and/or may include all or part of, the electronic system discussed below with respect to FIG. 4.

In the example of FIG. 1, each of the user devices 110 and 120 are depicted as a particular type of device, e.g., smartphone and desktop or portable computer. However, it is appreciated that each of the user devices 110 and 120 may be implemented as another type of device, such as a wearable device (e.g., a smart watch or other wearable device). The user devices 110 and/or 120 may be a device of a user (e.g., the user devices 110 and/or 120 may be associated with and/or logged into a user account for the user at a server, such as the subscription server 130).

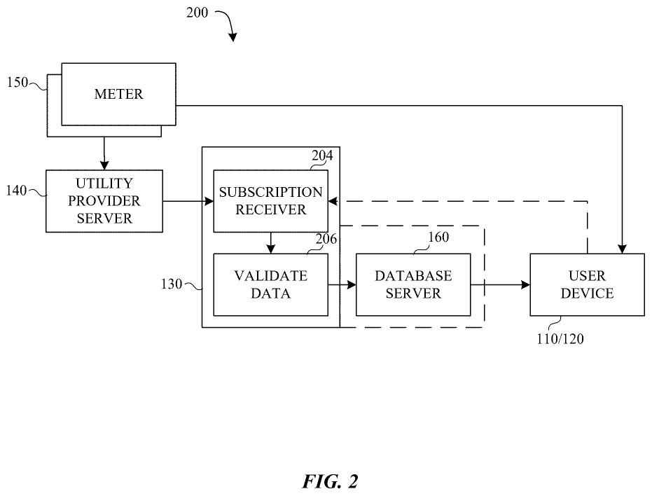

FIG. 2 illustrates a data flow diagram 200 for data flow among various devices for the utility usage information. Utility usage information is typically metered by a utility meter 150 at a service location for the utility. For example, a utility meter 150 may be located at a residence for utility usage at the residence. Multiple utility meters 150 may be available and each utility meter may cover a different type of utility, same type of utility, or combination thereof. For example, a first utility meter 150 may correspond to an electricity meter standing between an electric supply and a main residential electric panel (e.g., main breaker box) that measures the amount of electricity flowing through the electricity meter based on electrical demand by the main breaker box. Another utility meter 150 may correspond to a gas meter standing between a gas supply and a gas inlet into a residence that measures the amount of gas flowing through the gas meter based on gas demand of the residence. Yet another utility meter 150 may correspond to a water meter standing between a water supply, such as a municipal water supply, and a water inlet and/or sprinkler system of a residence that measures the amount of water flowing through the water meter based on water demand of the residence. Another utility meter 150 still may correspond to locally generated sources of power, such as one or more power controllers of solar grid array, wind turbine generator, or water wheel generator, etc. for electricity, or a water meter for a well water source for water. The utility meters 150 may collect usage data in accordance with industry standards and/or in compliance with regulatory bodies. The utility meters 150 may include communications interfaces which provide data to another device.

As noted in FIG. 2, in some instances, the utility meter 150 may provide usage data to the utility provider server 140. The utility provider server 140 may utilize this data to generate bills for the customer corresponding to the usage recorded at the utility meter 150. In one or more implementations, the utility meter 150 may provide usage data directly to the user device 110 or 120 in addition to the utility provider server 140. In some implementations, if the utility is at least in part generated locally, such as with a solar array generating electricity to at least partially meet the electric demand of the residence, the utility meter 150 provided by the utility company may be able to accommodate adding electricity back to the electric grid, and so can report utility usage in a downstream direction to the residence or utility provision in an upstream direction to the utility provider. In this scenario, however, the local utility usage of the residence provided by the solar array may not be captured by the utility provider, but rather only the net demand of the residence may be captured by the utility provider. In such instances, the local utility generation at the residence may measure the amount of the utility generated and/or used from that source and may report the utility generation and/or usage directly to the user device 110 and/or 120 and/or to another utility provider server 140, for example, corresponding to a solar power controller manufacturer tracking electricity generation.

The utility provider server 140 may provide the utility usage information received from the utility meter 150 to a subscription server 130. The utility usage information may be provided according to an established subscription for a particular customer of the utility provider server 140. The utility usage information may be provided along with a subscription identifier (ID) that establishes what subscription ID corresponds to what utility usage data. The subscription ID may correspond to a unique ID previously established among the user device 110 or 120, the subscription server 130, and the utility provider server 140. The subscription ID may be established when a utility customer enrolls in the utility data subscription using the user device 110 or 120. The enrollment process can request enrollment of the user device 110 or 120 through the utility provider server. The utility provider server can verify the user associated with the user device 110 or 120 as a customer of the utility provider server and as a customer of the service provider of the subscription server. The user device 110 or 120 may be validated and an authorization token issued to the subscription server 130 as well as the user device 110 or 120. The authorization can then be used to generate a subscription ID which is provided to each of the utility provider server 140, the subscription server 130, and the user device 110 or 120.

When the utility usage information is provided along with the subscription ID, the utility provider server 140 may aggregate all subscription data and provide a data transfer/download (e.g., a “data dump”) of all the subscription data for all customers at the same time, with the subscription data for each individual customer being associated with their subscription ID. In one or more implementations, the utility provider server 140 may provide utility usage information in the subscription data for each subscription ID incremental to the last subscription data provided. Thus, the utility provider server 140 need not provide a repeat of previously sent utility usage information in the subscription data, but may only provide the utility usage occurring since the last data dump. For example, each of the utility usage records may have a unique identifier, for example, based on the time of day that an instantaneous read was made at the utility meter 150.

In some instances, the established subscription may have been recently established and the utility usage data sent by the utility provider server 140 may be the first data provided for a new subscription. In such instances, the utility usage data may be sent either with the other data dump of subscription data or may be sent in a separate data transfer/download. In both cases, the utility usage data may include historical usage data going back a certain time period, such as about 12 to 24 months.

The utility provider server 140 can send the utility usage information to the subscription server 130 and, in particular, to a subscription receiver 204 of the subscription server 130. The subscription receiver 204 may include memory and logic to receive the utility usage information and cause it to be stored in the memory. The utility provider server 140 may be given permission to write the data to the subscription receiver 204 by a previously established access token provided by the subscription server 130 to the utility provider server 140. The access token can periodically be renewed. The access token and storage associated with the subscription receiver 204 can be configured to allow the utility provider server 140 to write utility usage information to the subscription receiver 204 but be prevented from reading or deleting data from the subscription receiver 204. In some implementations, the subscription receiver 204 can be configured to retrieve the utility usage information from a file repository of the utility provider server 140.

The utility usage information can be provided in any suitable format. In some implementations, the utility usage information includes record structures containing, for example, a record identifier (ID), a time stamp for a reading, a value for the utility measured or consumed which may be a total meter value, e.g., since the utility meter was installed or reset, or an incremental value representing an amount measured or consumed since the previous reading. The record may also include a meter ID, meter manufacturer information, meter model information, rate or tariff information for the measured time period, date of installation, firmware version of the meter, and so forth. In some instances, if the utility meter 150 was unable to be read, the utility provider can estimate utility usage based on previous usage and provide an estimated record which can be updated later. In such instances, the record can be marked as an estimate by the utility provider.

Next, the data is validated by the subscription server 130, at a validation process 206. The validation may include splitting the data records by subscription ID and checking each record corresponding to each subscription ID for consistent data, duplicate data, or conflicting data. For example, if the record includes a meter ID, the meter ID in each record can be verified as being from the same meter ID. In another example, if the usage data is out of a normal or typical range, the record can be flagged as anomalous. In another example, if a record has already been received with the same record identifier (ID), the data can be determined if it is in conflict with the already received data or should overwrite the already received data. Any questionable records can be flagged as questionable or anomalous and the subscription server 130 can re-request the records from the utility provider server 140.

After the records have been validated, they can be moved to a database server 160. The database server 160 can be considered a part of the subscription server 130 in some implementations (such as indicated by the dashed lines around the database server 160 attaching it to the subscription server 130 bounding box), while in other implementations, the database server 160 is a separate server from the subscription server.

The database server 160 can be logically or physically partitioned based on the subscription ID to prevent cross-mingling of data between subscription IDs. In some implementations, the database server 160 is a user-accessible database, that is, a user with appropriate credentials may access data in the database without the need to utilize an intermediate server (such as the subscription server 130) to access the data from the database. In such implementations the subscription server 130 may store the validated data in the database server 160 on behalf of the user associated with the subscription ID and the user and/or user's device can access the data without the need to go through the subscription server 130. In this manner, a user ID associated with the user device 110 and/or 120 and registered with the subscription server 130 may be divorced from the utility usage data of the subscription data, thereby preserving privacy of the user from the subscription server 130.

The records for the utility usage information in the database server 160 can be stored indefinitely until they are retrieved by the user device 110 and/or 120, in accordance with some implementations. In other implementations, the records for the utility usage information may be set to expire after a predetermined time period, after which, the data in the records may be deleted except for the record ID and/or replaced with a placeholder record including the record ID, thereby indicating that the record was received, but removed.

The user device 110 and/or 120 may access the utility usage information from the database server 160. The user device 110 and/or 120 may use a stored credential or other permission based on the subscription ID to access the records of the utility usage information and transfer them to the user device 110 and/or 120. The stored credential may be provided by the subscription server 130 to the user device 110 and/or 120. Other permission may include providing a username and password specifically set up for the database server 160. Thus, the user device 110 and/or 120 can access the stored utility usage information without sending a user ID associated with the user device 110 and/or 120. In some implementations, the user device 110 and/or 120 can access the utility usage information directly without going through the subscription server 130 because the information is stored in a user-accessible database server 160. In some implementations, the user device 110 and/or 120 can send the authentication information (i.e., stored credential or other permission) based on the subscription ID to the subscription server 130 to access the utility usage information. In both cases, however, a user ID associated with the user device 110 and/or 120 need not be sent to the subscription server 130, thereby helping to preserve the privacy of the user associated with the user device 110 and/or 120 and protect the usage data from being correlated with the user ID.

In some implementations, the user device 110 and/or 120 may delete data associated with the records and leave behind a placeholder record including the record ID. In other implementations, the subscription server 130 can cause the data associated with the records to be deleted and replaced with a placeholder record including the record ID.

The user device 110 and/or 120 may include an application or system process running thereon which performs such processes and may further utilize the utility usage information from the subscription data to provide information to the user device 110 and/or 120 information regarding the utility usage associated with a user of the user device 110 and/or 120.

As also seen in FIG. 2, and as noted above, the user device 110 and/or 120 may, in some implementations, receive utility usage information directly from the utility meter 150. In such implementations, the utility usage information may correspond to generated utility supply, such as described above by example with the solar panel array. In such cases the utility usage information may be derived from the generation by adding the utility usage from another supplier of the same type of resource with the utility generation at the residence. For example, if the utility is electricity and a residence uses 15 kWh in one day according to the utility usage information received via the subscription data and generates 20 kWh in the same time period from a solar panel array or wind turbine generator, the generated utility can be understood as being consumed at the residence. Thus, the total usage for the day is 35 kWh. In another example, supposing a case where the solar panel array is grid-tied and generates more energy than is used, then the total usage from the utility provider server 140 may be −5 kWh and the total energy produced may be 25 kWh, indicating that a total of 20 kWh was consumed at the residence.

In some implementations, the user device 110 and/or 120 may optionally send the utility usage information back to the subscription server 130, thereby giving the subscription server 130 permission to utilize the utility usage information for statistical analysis and/or to compare the utility usage information to the usage data of other users who have also shared their data back to the subscription server 130. The utility usage information sent back to the subscription server 130 may be anonymized to enhance privacy.

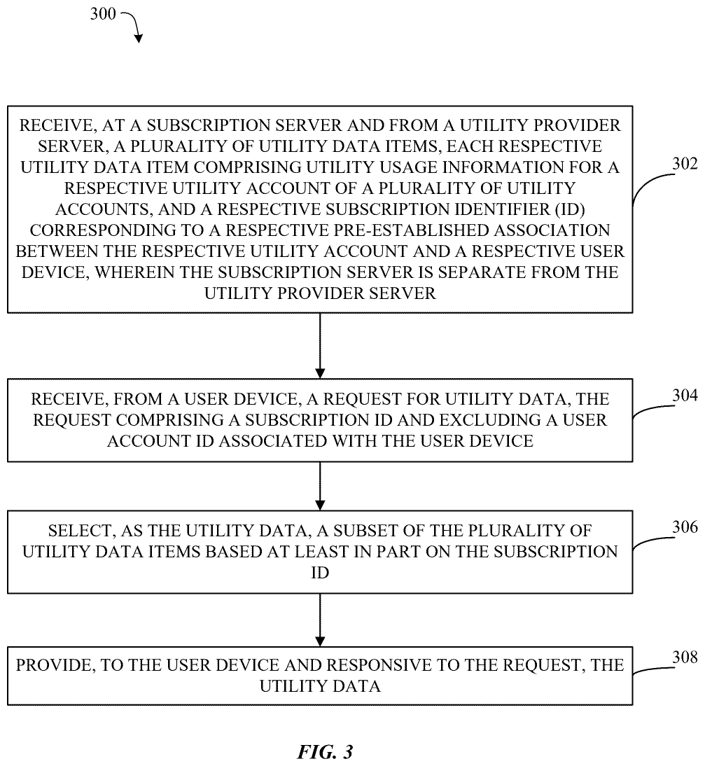

FIG. 3 illustrates a flow diagram of an example process 300 for providing utility usage data to a user device. The process 300 may be performed by one or more devices, such as the subscription server 130, the database server 160, or a combination of the subscription server 130 and database server 160, described above with respect to FIG. 1. One or more blocks (or operations) of the process flow diagram of FIG. 3 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 302, process 300 may include receiving at a subscription server and from a utility provider server, a plurality of utility data items, each respective utility data item comprising utility usage information for a respective utility account of a plurality of utility accounts, and a respective subscription identifier (ID) corresponding to a respective pre-established association between the respective utility account and a respective user device, wherein the subscription server is separate from the utility provider server. The utility provider server and the subscription server may be controlled by different entities, but each entity may have a common customer. The customer of the utility provider, for example, may be the same as or in the same household as the customer of the subscription server provider.

As noted above, the utility usage information, e.g., utility data items, may be based on a subscription ID previously established between the user device, the subscription server, and the utility provider server. The establishing of the subscription ID may be done in a manner which preserves the privacy of the user utility data because the utility provider server establishes the subscription by a process with the user directly. Because the user is also a customer of the subscription server, then the subscription server may have a user ID (e.g., a user account ID) associated with the user, but the user ID need not be associated with the subscription ID.

The utility data items may each include utility usage records, such as those discussed above. In particular, the utility data items may include meter readings for utility meters associated with the residence. In the case where the residence may have multiple utility meters, a primary utility meter may be selected as being representative of utility usage or data from all the available utility meters may be accommodated. The utility data items may be received from the utility provider server by the utility provider server writing the utility data items to a remote accessible storage location of the subscription server, which is accessed using an authorization credential. The authorization credential may correspond to an access token issued by the subscription server to the utility provider server, the access token providing the ability for the utility provider server to directly access a data storage facility of the subscription server to store the utility data items. In other implementations the utility data items may be requested from the subscription server and received in response to the request. The utility data items may include data items corresponding to multiple different subscription IDs.

The utility data items may be stored at a database server associated with the subscription server. Also, as noted above, the process 300 may be performed by such a database server, such that the subscription server of the process 300 may be understood to correspond to a database server, such as the database server 160. In other implementations, some of the blocks of the process 300 may be performed by a subscription server, such as the subscription server 130, and some of the blocks may be performed by a database server, such as the database server 160. It should be understood, for example, that the database server can be considered a part of subscription server or distinct from the subscription server, such as discussed above with respect to FIG. 2, and depending on the context.

In some implementations, the utility data items may be validated after receiving the utility data items and prior to storing the utility data items for retrieval by the user device. Such validation may be performed by a validation process, such as the validation process 206 described above with respect to FIG. 2.

In some implementations, when the utility data items for a particular subscription ID correspond to a newly established subscription ID, the utility data items may include historical utility data records, e.g., coming from a time period prior to the setting up of the subscription ID. The number of historical records may vary, and may include, for example the prior six to twenty-four months of data, though other values may be used. Thus, the start date for the historical time period may be set to correspond to a predefined time period, such as 6 to 24 months prior to the day that the subscription ID was established. For example, if the subscription ID was established on Jun. 17, 2028, then the historical data may be provided for the historical time period beginning on Jun. 17, 2026, or another date based on the predefined time period.

When the utility is electricity, and the utility provider is an electricity provider, the utility data may correspond to electricity measured at an electric meter. The electric meter may support bidirectional electricity flow, for example, when a solar grid is generating more power than the residence needed, the excess power may be provided back into the power grid. The utility data can include an indication when usage data is positive (coming from the power grid to the residence) or negative (going from the residence to the power grid).

At block 304, process 300 may include receiving, from a user device, a request for utility data, the request comprising a subscription ID and excluding a user account ID associated with the user device. Because the records are kept at the subscription server in a privacy preserving way (e.g., without storing a user account ID or other user ID at the subscription server), then the request for utility data from the user device need not include a user ID. The request for utility data can include other authentication information, such as authentication information related to the subscription ID. The user device may request the utility data, for example, as part of their subscription with the utility provider server, e.g., from an application or system process running in the user device.

At block 306, process 300 may include selecting, as the utility data, a subset of the plurality of utility data items based at least in part on the subscription ID. The subset of the plurality of utility data items, for example, may correspond to the utility data items that match the subscription ID included in the request. In some implementations, the subset may include only those utility data items which have been validated and determined to be valid. In some implementations.

At block 308, process 300 may include providing, to the user device and responsive to the request, the utility data. In some implementations, the providing the utility data may correspond to transferring copies of the utility usage data from a user-accessible database to the user device. In some implementations, the providing the utility data may correspond to retrieving the utility data from a storage location and providing the utility data to the user device.

In some implementations, after providing the utility data, the utility data may be removed or deleted from the subscription server and/or database server. In some instances, when the utility data is removed or deleted a placeholder record may be left behind and continue to be stored, including for example, a record ID, and, in some instances, an indication that the record was provided to the user device. The user device can initiate the record removal or the subscription server may initiate the record removal.

In some implementations, the utility data provided to the user device may include utility data corresponding to a record ID or usage time period which was previously provided, but which the utility provider server desired to resend. The user device can replace the previously received data with the updated data, for example, because the previously sent data may have been an estimate or may have had anomalous data therein.

The process 300 may also include, storing utility data according to the subscription ID, after a predetermined time period, replacing the utility data with a placeholder record indicating the second utility data was removed. The utility data can, in a sense, expire, and rather than continue to retain the data, the subscription server can cause the utility data to be removed and replaced with a placeholder record that may include, a record ID, and in some instances, an indication that the record was expired.

Subsequently to removing the expired and/or otherwise removed utility data with a placeholder, a request can be received for the removed data. For example, if expired, the request from the utility data can include a request for the utility data which was removed. In such instances, the subscription server can request the data from the utility provider server and replace the placeholder records with the usage data. The utility data may then be provided to the user device as described above.

In some implementations, the process 300 may also include receiving rate information for a plurality of rate plans related to the utility data, correlating the rate information with the utility data, and providing the correlated rate information to the user device. The rate or tariff information may include a rate plan associated with the utility customer's utility data. Rate plans may be based on fixed rate, variable rate, time of use rates, tiered rates, and so forth. The rate information may then by correlated with usage data based on the time period of the usage, the amount of the usage, the aggregated usage, and so forth. In some implementations, the utility data received from the utility provider may include rate or tariff codes, which can be correlated with rate or tariffs based on those codes. The code data can be replaced with the correlated data prior to providing to the user device. In some implementations, the user device can provide the utility data back to the subscription server and the subscription server can then substitute the rate or tariff information based on the rate or tariff code and send the updated utility data back to the user device.

In some implementations, the user device may elect to provide or share the utility data back to the subscription server. In such implementation, the subscription server can apply tariff rules, such as described above, or calculate statistical analysis on the data. For example, the subscription server can provide information on a usage, such as trends or other statistical analysis, in various demographic or geographic groups. The subscription server can provide a comparison of use to the user device that compares the received user device data to the usage statistics generated from multiple users. In some implementations, the utility data shared back to the subscription server may include utility data from multiple sources, including, for example, utility data received directly at the user device from a utility meter or equivalent, and the subscriptions server may aggregate the utility data to obtain a comprehensive picture of the usage data for that type of utility. For example, if the utility is electricity and the user device has solar power energy generation utility data, that utility data can be aggregated with the utility data from another electricity provider and a comprehensive utility usage or aggregate can be provided back to the user device. This data can also be included in the statistical analysis for energy trends among subscribers.

As described above, one aspect of the present technology is the gathering and use of data available from specific and legitimate sources for providing subscription utility data related to a customer of a utility provider to a subscription server and the subscription server providing the subscription data to user device. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for operating an electronic device (e.g., user device) to provide utility usage information to the electronic device. Accordingly, use of such personal information data may facilitate transactions (e.g., on-line transactions). Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating a user device to provide utility information, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 4 illustrates an electronic system 400 with which one or more implementations of the subject technology may be implemented. The electronic system 400 can be, and/or can be a part of, one or more of the user device 110, user device 120, subscription server 130, utility provider server 140, utility meter 150, and/or database server 160. The electronic system 400 may include various types of computer readable media and interfaces for various other types of computer readable media. The electronic system 400 includes a bus 408, one or more processing unit(s) 412, a system memory 404 (and/or buffer), a ROM 410, a permanent storage device 402, an input device interface 414, an output device interface 406, and one or more network interfaces 416, or subsets and variations thereof.

The bus 408 collectively represents all system, peripheral, and chipset buses that communicatively connect the numerous internal devices of the electronic system 400. In one or more implementations, the bus 408 communicatively connects the one or more processing unit(s) 412 with the ROM 410, the system memory 404, and the permanent storage device 402. From these various memory units, the one or more processing unit(s) 412 retrieves instructions to execute and data to process in order to execute the processes of the subject disclosure. The one or more processing unit(s) 412 can be a single processor or a multi-core processor in different implementations.

The ROM 410 stores static data and instructions that are needed by the one or more processing unit(s) 412 and other modules of the electronic system 400. The permanent storage device 402, on the other hand, may be a read-and-write memory device. The permanent storage device 402 may be a non-volatile memory unit that stores instructions and data even when the electronic system 400 is off. In one or more implementations, a mass-storage device (such as a magnetic or optical disk and its corresponding disk drive) may be used as the permanent storage device 402.

In one or more implementations, a removable storage device (such as a flash drive) may be used as the permanent storage device 402. Like the permanent storage device 402, the system memory 404 may be a read-and-write memory device. However, unlike the permanent storage device 402, the system memory 404 may be a volatile read-and-write memory, such as random access memory. The system memory 404 may store any of the instructions and data that one or more processing unit(s) 412 may need at runtime. In one or more implementations, the processes of the subject disclosure are stored in the system memory 404, the permanent storage device 402, and/or the ROM 410. From these various memory units, the one or more processing unit(s) 412 retrieves instructions to execute and data to process in order to execute the processes of one or more implementations.

The bus 408 also connects to the input and output device interfaces 414 and 406. The input device interface 414 enables a user to communicate information and select commands to the electronic system 400. Input devices that may be used with the input device interface 414 may include, for example, alphanumeric keyboards and pointing devices (also called “cursor control devices”). The output device interface 406 may enable, for example, the display of images generated by electronic system 400. Output devices that may be used with the output device interface 406 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 4, the bus 408 also couples the electronic system 400 to one or more networks and/or to one or more network nodes, through the one or more network interface(s) 416. In this manner, the electronic system 400 can be a part of a network of computers (such as a LAN, a wide area network (“WAN”), or an Intranet, or a network of networks, such as the Internet. Any or all components of the electronic system 400 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device (e.g., user device).

As used herein, the phrase “at least one of” preceding a series of items, with the term “and” or “or” to separate any of the items, modifies the list as a whole, rather than each member of the list (i.e., each item). The phrase “at least one of”' does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, at a subscription server and from a utility provider server, a plurality of utility data items, each respective utility data item comprising utility usage information for a respective utility account of a plurality of utility accounts, and a respective subscription identifier (ID) corresponding to a respective pre-established association between the respective utility account and a respective user device, wherein the subscription server is separate from the utility provider server;
receiving, from a user device, a request for utility data, the request comprising a subscription ID and excluding a user account ID associated with the user device;
selecting, as the utility data, a subset of the plurality of utility data items based at least in part on the subscription ID; and
providing, to the user device and responsive to the request, the utility data.

2. The method of claim 1, wherein the request further comprises authentication information.

3. The method of claim 1, wherein the subscription server comprises a database server, wherein the request is received directly at the database server.

4. The method of claim 3, wherein the user account ID is absent from the utility data and absent from the database server.

5. The method of claim 3, further comprising:
validating the utility data prior to storing the utility data in the database server.

6. The method of claim 3, further comprising:
after providing the utility data to the user device, removing the utility data from the database server.

7. The method of claim 6, wherein the utility data is first utility data, further comprising:
storing second utility data in the database server according to the subscription ID; and
after a predetermined time period, replacing the second utility data in the database server with a placeholder record indicating the second utility data was removed.

8. The method of claim 7, further comprising:
after the second utility data has been replaced with the placeholder record, receiving a request for the second utility data;
requesting, from the utility provider server, the second utility data; and
providing the second utility data to the user device based on the request for the second utility data.

9. The method of claim 1, wherein when the utility data is for a newly established subscription, the utility data includes historical data.

10. The method of claim 9, wherein the historical data has a start date which corresponds to a predefined time period.

11. The method of claim 1, further comprising:
receiving rate information for a plurality of rate plans related to the utility data;
correlating the rate information with the utility data; and
providing the correlated rate information to the user device.

12. The method of claim 1, further comprising:
receiving an indication of permission from the user device to access the utility data for analysis;
calculating usage trends for utility usage data for a plurality of subscription IDs; and
providing usage trend data to the user device.

13. The method of claim 1, wherein a utility provider associated with the utility provider server is an electricity provider, wherein the utility data corresponds to electricity measured at an electric meter, and wherein the utility data includes electricity information for electricity provided by the electricity provider and for electricity provided to the electricity provider.

14. The method of claim 1, further comprising:
issuing an access token to the utility provider server, the access token providing the ability for the utility provider server to directly access a data storage facility of the subscription server.

15. The method of claim 1, further comprising:
receiving, at the subscription server, replacement utility data to replace an already received portion of the utility data, wherein both the replacement utility data and the already received portion of the utility data correspond to a same time-period.

16. The method of claim 1, wherein the utility data is first utility data, further comprising:
receiving second utility data from the user device;
aggregating the second utility data from the user device with the first utility data from the utility provider server; and
providing the aggregated data to the user device.

17. A device comprising:
a processor;
a non-transitory computer-readable medium storing instructions, which when executed, cause the processor to:
receive, at the device and from a utility provider server, a plurality of utility data items, each respective utility data item comprising utility usage information for a respective utility account of a plurality of utility accounts, and a respective subscription identifier (ID) corresponding to a respective pre-established association between the respective utility account and a respective user device, wherein the device is separate from the utility provider server;
receive, from a user device, a request for utility data, the request comprising a subscription ID and excluding a user account ID associated with the user device;
select, as the utility data, a subset of the plurality of utility data items based at least in part on the subscription ID; and
provide, to the user device and responsive to the request, the utility data.

18. The device of claim 17, wherein the device comprises a database server, wherein the request is received directly at the database server.

19. The device of claim 18, wherein the user account ID is absent from the utility data and absent from the database server, wherein the instructions further cause the processor to:
validate the utility data prior to storing the utility data in the database server; and
after providing the utility data to the user device, removing the utility data from the database server.

20. A non-transitory computer readable medium storing instructions which, when executed by one or more processors, cause the one or more processors to:
receive, at a subscription server and from a utility provider server, a plurality of utility data items, each respective utility data item comprising utility usage information for a respective utility account of a plurality of utility accounts, and a respective subscription identifier (ID) corresponding to a respective pre-established association between the respective utility account and a respective user device, wherein the subscription server is separate from the utility provider server;
receive, from a user device, a request for utility data, the request comprising a subscription ID and excluding a user account ID associated with the user device;
select, as the utility data, a subset of the plurality of utility data items based at least in part on the subscription ID; and
provide, to the user device and responsive to the request, the utility data.
